(19) United States
(12) Patent Application Publication
(10) Pub. No.: US 2023/0087013 A1
(43) Pub. Date: Mar. 23, 2023

(54) VEHICLE COMPONENT CONVEYANCE APPARATUS AND VEHICLE COMPONENT CONVEYANCE METHOD

(71) Applicant: HONDA MOTOR CO., LTD., Tokyo (JP)

(72) Inventors: Takayuki Hoshino, Tochigi (JP); Koji Oda, Tochigi (JP)

(21) Appl. No.: 17/913,557

(22) PCT Filed: Feb. 22, 2021
(86) PCT No.: PCT/JP2021/006622

§ 371 Date: Sep. 22, 2022

(30) Foreign Application Priority Data
Mar. 27, 2020 (JP) 2020-058356

(51) Int. Cl. B62D 65/18

(52) U.S. Cl. CPC B62D 65/18

(57) ABSTRACT

The present invention provides a vehicle component conveyance apparatus and a vehicle component conveyance method with which it is possible to easily convey an assembly component while maintaining a posture thereof. A conveyance apparatus 10 conveys an assembly component temporarily assembled by bonding, with an uncured adhesive, contact portions of base parts 101 and 102, side parts 103 and 104, a rear part 105, and an upper part 106. The conveyance apparatus 10 includes a temporary assembly jig 20 and a conveyance means 40. The temporary assembly jig 20 has a base 21, base-part support portions 23 and 25, side-part support portions 27, and a rear-part support portion 29. The side-part support portions 27 each have a pressing portion 31 that presses the pair of side parts 103 and 104 from outside toward inside in a vehicle width direction.

### TECHNICAL FIELD

The present invention relates to a vehicle component conveyance apparatus and a vehicle component conveyance method for conveying a temporarily assembled assembly component including a plurality of parts while maintaining a temporarily assembled state thereof.

### BACKGROUND ART

In general, a vehicle body is formed by welding and integrating an assembly component including a plurality of parts to another component. An assembly component may also have parts welded to one another or bonded with an adhesive.

For example. Patent Literature 1 below describes an automobile assembling method in which a pressure-sensitive adhesive is interposed between joint portions of adherends to be joined, and then the joint portions are pressurized to join the adherends with the adhesive. Further. Patent Literature 1 below describes that when a product is conveyed in a state where an adhesive is not cured to practical strength, adherends may be displaced or peeled off, and thus the adherends are fastened by a fastening means such as a clamp.

### CITATION LIST

### Patent Literature

Patent Literature 1: JP 59-15471 A

### SUMMARY OF INVENTION

### Technical Problem

In an invention of Patent Literature 1 described above, after a pressure sensitive adhesive is interposed between joint portions of adherends, the joint portions are pressurized by a pressing machine or the like in order to pressurize the joint portions, which requires a large-scale device and is complicated, and it is difficult to easily convey a product while maintaining postures of the adherends.

Therefore, an object of the present invention is to provide a vehicle component conveyance apparatus and a vehicle component conveyance method capable of easily conveying an assembly component while maintaining a posture thereof in a state where each part is temporarily assembled with an adhesive.

### Solution to Problem

In order to achieve the above object, one aspect of the present invention is a vehicle component conveyance apparatus that conveys an assembly component temporarily assembled by bonding, with an uncured adhesive, contact portions of a pair of base parts disposed on both sides in a vehicle width direction, a pair of side parts disposed in contact with an outside of the pair of base parts, a rear part disposed in contact with a vehicle rear side of the pair of base parts, and an upper part disposed in contact with a vehicle upper side of the pair of side parts and the rear part, the vehicle component conveyance apparatus comprising a temporary assembly jig that maintains a temporary assembling state of the assembly component, and a conveyance means that conveys the temporary assembly jig, wherein the temporary assembly jig includes a base, a base-part support portion that supports the pair of base parts, a side-part support portion that supports the pair of side parts at a predetermined height, and a rear-part support portion that is provided on the vehicle rear side behind the base-part support portion and the side-part support portion and supports the rear part, the upper part is supported above the pair of side parts and the rear part supported by the side-part support portion and the rear-part support portion, and the side-part support portion includes a pressing portion that presses the pair of side parts supported by the side-part support portion from outside toward inside in the vehicle width direction.

Another aspect of the present invention is a vehicle component conveyance method for conveying an assembly component temporarily assembled by bonding, with an uncured adhesive, contact portions of a pair of base parts disposed on both sides in a vehicle width direction, a pair of side parts disposed in contact with an outside of the pair of base parts, a rear part disposed in contact with a vehicle rear side of the pair of base parts, and an upper part disposed in contact with a vehicle upper side of the pair of side parts and the rear part, wherein the pair of side parts are pressed from outside toward inside in the vehicle width direction to convey the assembly component while maintaining a temporarily assembled state thereof, in a state where a temporary assembly jig conveyed by a conveyance means supports: the pair of base parts; the pair of side parts outside of the pair of base parts and at a predetermined height; the rear part behind the pair of base parts; and the upper part above the pair of side parts and the rear part.

According to the above invention, an assembly component temporarily assembled with an adhesive is conveyed while the pair of side parts is pressed from outside toward inside in the vehicle width direction in a state where the pair of base parts, the pair of side parts, the rear part, and the upper part are respectively supported. Therefore, even if an uncured adhesive is used, it is possible to easily convey an assembly component while maintaining postures of the pair of base parts, the pair of side parts, and the rear part without pressurizing the respective parts with a press or the like as in Patent Literature 1. As a result, workability such as a welding work after conveyance can be improved.

### Advantageous Effects of Invention

According to the present invention, since an assembly component is conveyed while pressing a pair of side parts from outside toward inside in a vehicle width direction, the assembly component can be conveyed while maintaining a posture of each part, and workability such as a welding work after conveyance can be improved.

### BRIEF DESCRIPTION OF DRAWINGS

FIG. 1 is a schematic explanatory block diagram illustrating an embodiment of a vehicle component conveyance apparatus and a vehicle component conveyance method according to the present invention.

FIG. 2 is a schematic configuration diagram of the vehicle component conveyance apparatus.

FIG. 3 is an explanatory view of an assembly component temporarily assembled by a temporary assembly jig constituting the vehicle component conveyance apparatus.

FIG. 4 is an explanatory view of the temporarily assembled assembly component.

FIG. 5 is a table for explaining performance of an adhesive used for temporary assembly.

FIG. 6 is a perspective view of a temporary assembly jig constituting the vehicle component conveyance apparatus.

FIG. 7 illustrates a temporary assembling work using the temporary assembly jig and is an explanatory view illustrating a first process thereof.

FIG. 8 is an explanatory view illustrating a second process of the temporary assembling work.

FIG. 9 is an explanatory view illustrating a third process of the temporary assembling work.

FIG. 10 is an explanatory view illustrating a fourth process of the temporary assembling work.

### DESCRIPTION OF EMBODIMENTS

Hereinafter, an embodiment of a vehicle component conveyance apparatus and a vehicle component conveyance method according to the present invention will be described with reference to the drawings. First, the vehicle component conveyance apparatus will be described.

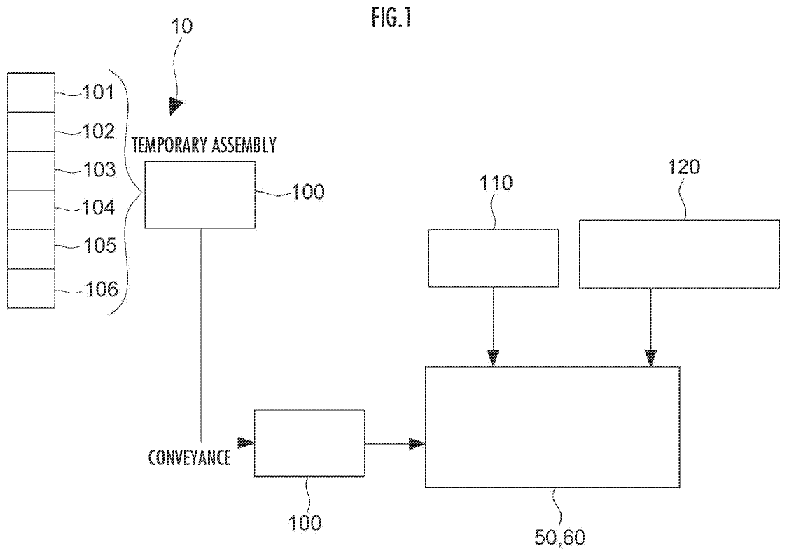

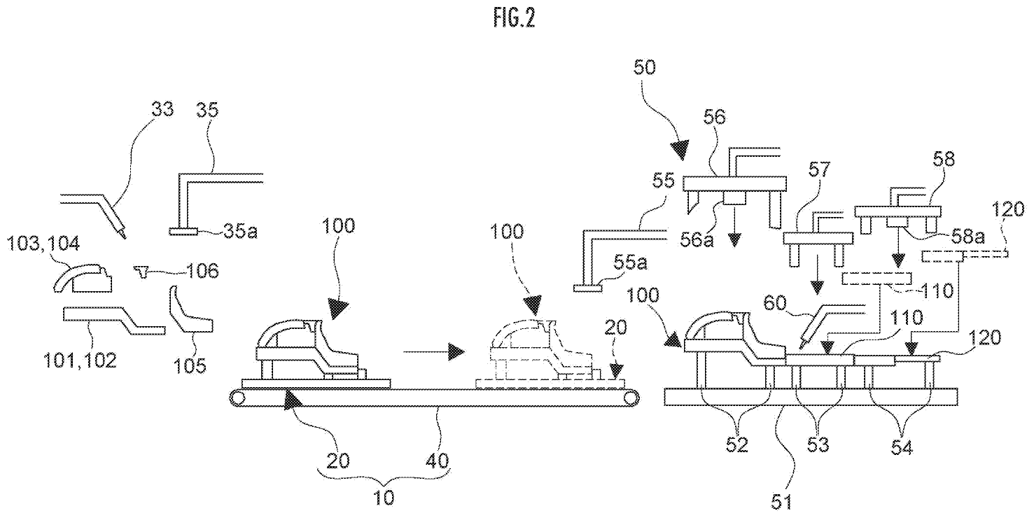

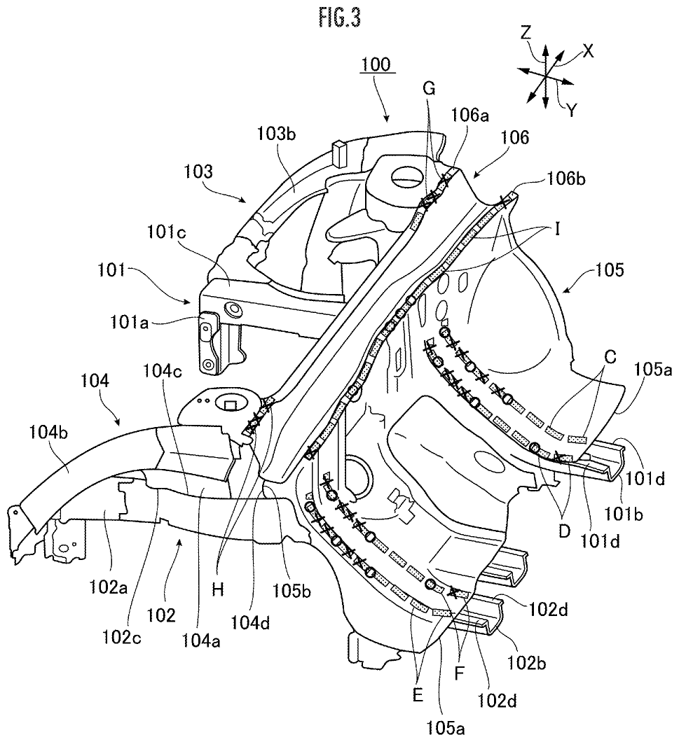

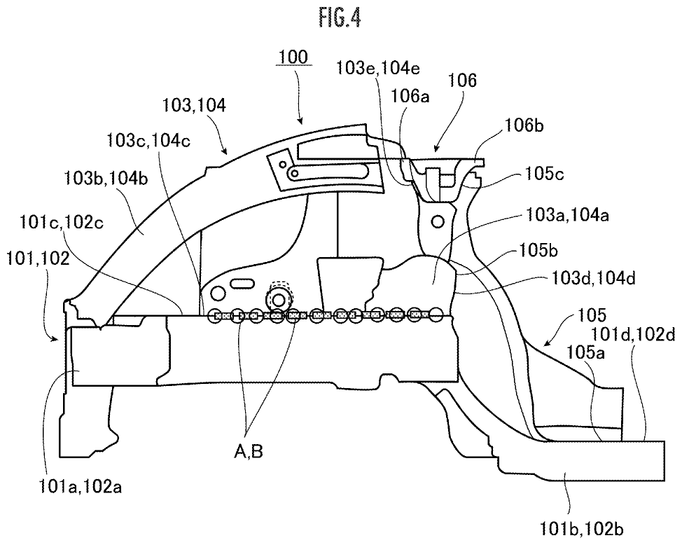

As illustrated in FIGS. 1 and 2, a vehicle component conveyance apparatus 10 according to the present embodiment (hereinafter also simply referred to as the “conveyance apparatus 10”) conveys an assembly component 100 as illustrated in FIGS. 3 and 4, temporarily assembled by bonding, with an uncured adhesive, contact portions of a pair of base parts 101 and 102 disposed on both sides in a vehicle width direction (X direction in FIG. 3), a pair of side parts 103 and 104 disposed in contact with an outside of the pair of base parts 101 and 102, a rear part 105 disposed in contact with a vehicle rear side of the pair of base parts 101 and 102, and an upper part 106 disposed in contact with a vehicle upper side of the pair of side parts 103 and 104 and the rear part 105 (see bonded portions C, D, E, F, G, H, and I in FIG. 3 and bonded portions A and B in FIG. 4). Note that the above-described “bonded portions” means portions where parts contact with each other and are bonded by an adhesive (the same applies to the following descriptions). In addition, in this embodiment, the pair of base parts 101 and 102 has a bilaterally symmetrical symmetry shape, and similarly, the pair of side parts 103 and 104 has a bilaterally symmetrical symmetry shape.

In the following descriptions. “front” means a vehicle front when a vehicle body is completed, and “front end” means a vehicle front end when a vehicle body is completed. In addition. “rear” means a vehicle rear when a vehicle body is completed, and “rear end” means a vehicle rear end when a vehicle body is completed.

In this embodiment, as illustrated in FIGS. 2 to 4, the assembly component 100 including a plurality of parts is a front component disposed on a vehicle front side. In addition, as illustrated in FIG. 2, an assembly component 120 including a plurality of parts is a rear floor component disposed behind the assembly component 100 on a floor side. Further, as illustrated in FIG. 2, a component 110 including one part is a floor component disposed between the assembly components 100 and 120. A vehicle body is formed by disposing the component 110 between the assembly components 100 and 120 and welding joint portions of the components 100, 110, and 120 to each other (see FIG. 2).

The base parts 101 and 102 are so-called front side frames and include base portions 101a and 102a extending by a predetermined length in a vehicle longitudinal direction (Y direction in FIG. 3) and extending portions 101b and 102b having a substantially U-shaped frame shape (including a bottom wall and a pair of side walls) extending from rear end portions of the base portions 101a and 102a in an extending direction via inclined portions.

The side parts 103 and 104 are so-called wheel house housings and include outer wall portions 103a and 104a disposed outside the base parts 101 and 102 and arm portions 103b and 104b that extend while curving obliquely forward, inside the outer wall portions 103a and 104a.

The rear part 105 is a so-called dashboard lower, extends in the vehicle width direction, and has a shape substantially conforming to upper surface shapes of the extending portions 101b and 102b of the pair of base parts 101 and 102 and rear end surface shapes of the outer wall portions 103a and 104a of the pair of side parts 103 and 104.

The upper part 106 is a so-called dashboard upper, has a substantially U-shaped frame shape formed by a bottom wall and a pair of side walls, and has a shape extending in the vehicle width direction. A front tongue piece 106a protrudes toward a vehicle front from an upper end edge of the side wall on the vehicle front side, and a rear tongue piece 106b protrudes toward a vehicle rear from the upper end edge of the side wall on the vehicle rear side.

Note that the assembly component 120 also includes a plurality of parts (for example, a rear side frame, a plurality of cross members, and the like), but this is omitted for convenience.

Further, a vehicle body according to this embodiment is formed by assembling a plurality of assembly components 100 and 120 and the component 110 including one part (see FIG. 2), but the vehicle body may include, for example, only the assembly components (a configuration in which there is no component including one part). In addition, shapes and number of components forming a vehicle body, and shapes, number, and the like of parts included each component are not limited to the above aspects.

The conveyance apparatus 10 includes a temporary assembly jig 20 that maintains a temporarily assembled state of the assembly component 100 and a conveyance means 40 that conveys the temporary assembly jig 20.

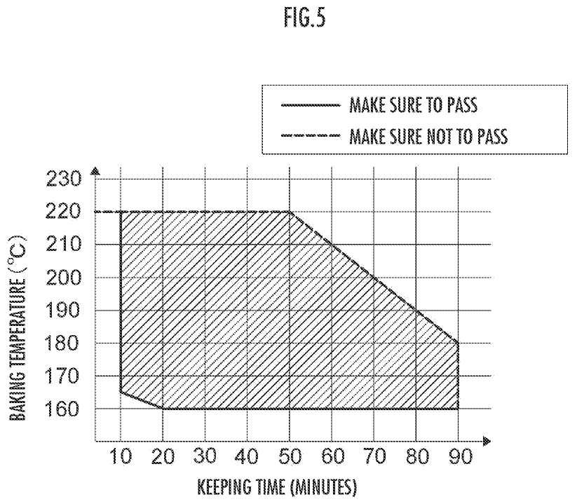

An adhesive according to this embodiment is a so-called high viscosity adhesive such as a one-component thermosetting epoxy adhesive or a one-component thermosetting acrylic adhesive and has thixotropy. Thixotropy refers to a property in which viscosity increases to become solid in a stationary condition, whereas viscosity decreases to become liquid when a shear stress continues to be applied and a shear rate increases. This adhesive is cured by being heated at a predetermined temperature. Further, as illustrated in FIG. 5, in the adhesive according to this embodiment, when a horizontal axis represents keeping time (minutes) and a vertical axis represents a baking temperature (° C.), it is preferred that the above-described performance (thixotropy, thermosetting property, and the like) be guaranteed within an electrodeposition baking window in FIG. 5 (a hatching area with oblique lines in FIG. 5).

In addition, a viscosity force and a shape retaining force of the adhesive are low when continuously receiving a continuous force but are strong when temporarily receiving an instantaneous force. Further, a viscosity force of an adhesive is stronger when a force in a peeling direction is applied than when a force in a shearing direction is applied. In short, a viscosity force of an adhesive is weak against a shearing force. In consideration of such properties of an adhesive, the temporary assembly jig 20 is configured to retain a shape of an assembly component in a stationary condition.

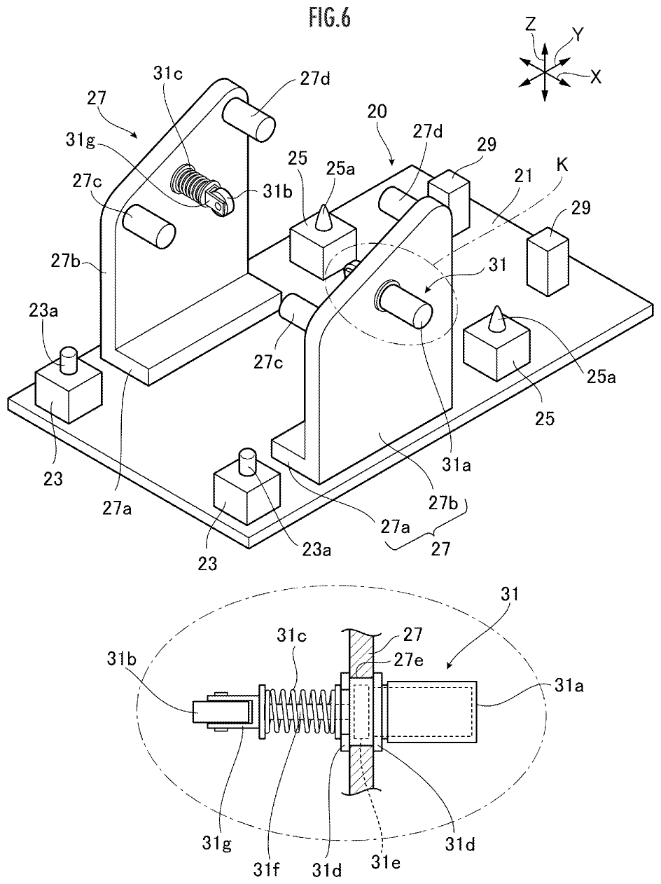

Referring also to FIG. 6, the temporary assembly jig 20 according to this embodiment includes a base 21, base-part support portions 23 and 25 that support the pair of base parts 101 and 102, side-part support portions 27 that support the pair of side parts 103 and 104, and rear-part support portions 29 that support the rear part 105.

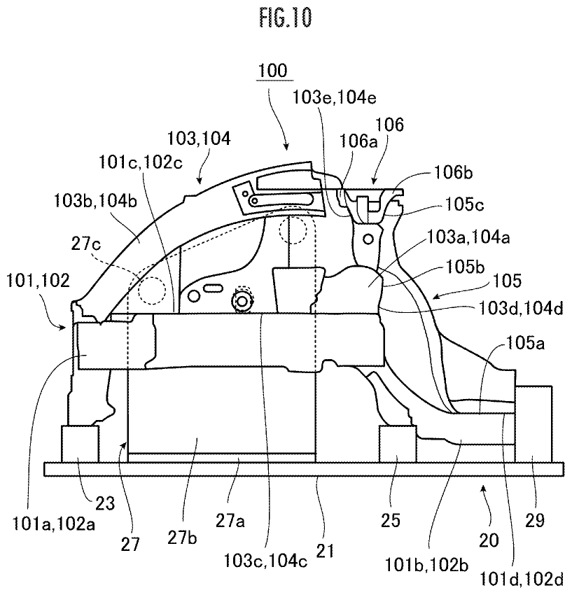

The temporary assembly jig 20 can maintain correlative positions, postures, and the like between the parts so that a predetermined part is not displaced from another part, or a predetermined part does not fall. The temporary assembly jig 20 according to this embodiment is a contact portion of each part and has, in a direction in which a shearing force acts, a structure in which the receiving members (base-part support portions 23 and 25, side-part support portions 27, and rear-part support portions 29) are provided in order to receive the shearing force, but has, in its own weight direction (gravity direction) in which a shearing force does not act, a structure supported only with an adhesive without the receiving members described above (supporting structure of the upper part 106 illustrated in FIG. 10).

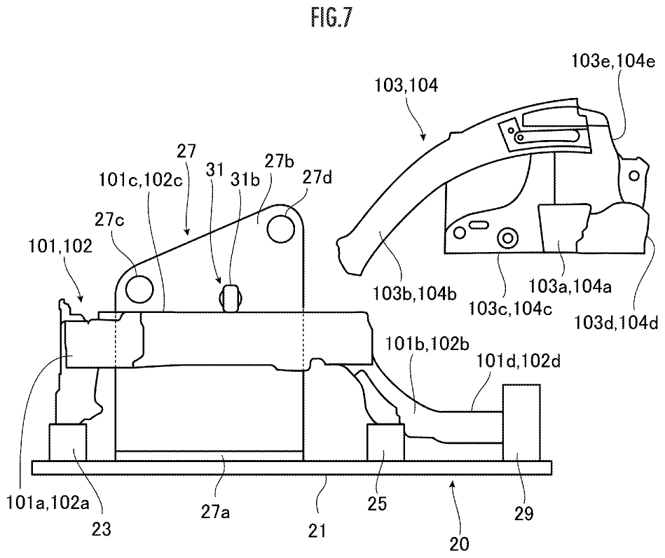

Specifically describing each member, the base 21 has a rectangular plate shape extending long in the vehicle longitudinal direction. The base-part support portions 23 and 23 each having a substantially rectangular parallelepiped shape are provided in a protruding condition on the vehicle front side of the base 21 (one end side in the Y direction in FIG. 6) and from upper surfaces on both sides in the width direction (the X direction side in FIG. 6). A support pin 23a protrudes from an upper surface of each base-part support portion 23. Then, fronts of lower surfaces of the base portion 101a of the base part 101 and the base portion 102a of the base part 102 are supported by the base-part support portions 23 and 23 via the support pins 23a and 23a (see FIGS. 7 to 10). For convenience, the support pins 23a are omitted in FIGS. 7 to 10.

The base-part support portions 25 and 25 each having a substantially rectangular parallelepiped shape are provided in a protruding condition on the vehicle rear side behind the base-part support portions 23 and 23 (the other end side in the Y direction in FIG. 6) and from the upper surfaces on both sides in the width direction. A support pin 25a protrudes from an upper surface of each base-part support portion 25. Then, rears of lower surfaces of the extending portion 101b of the base part 101 and the extending portion 102b of the base part 102 are supported by the base-part support portions 25 and 25 via the support pins 25a and 25a (see FIGS. 7 to 10). Each of the support pins 25a also serves to drain water accumulated on each part of the assembly component 100. For convenience, the support pins 25a are omitted in FIGS. 7 to 10.

Further, the side-part support portions 27 and 27 are provided between the base-part support portions 23 and 25 on both sides of the base 21 in the width direction. Each of the side-part support portions 27 has a bottom wall 27a fixed to an upper surface of the base 21 and a side wall 27b erected from the bottom wall 27a. A support pin 27c protrudes from an inner surface side of an upper edge of each side wall 27b and from the vehicle front side toward an inside of the base 21 so as to be orthogonal to the side wall 27b. Further, a support pin 27d protrudes from the inner surface side of the upper edge of each side wall 27b and from the vehicle rear side toward the inside of the base 21 so as to be orthogonal to the side wall 27b. The support pin 27d is provided at a position higher than the support pin 27c in a Z direction of FIG. 6.

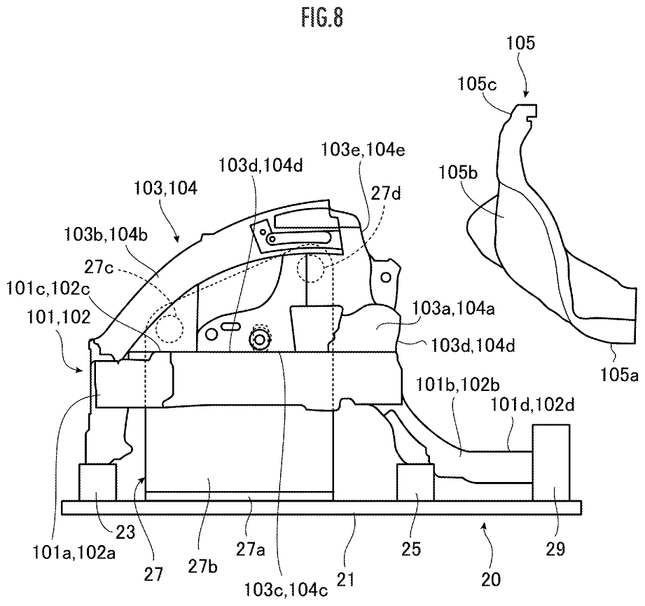

The support pins 27c support portions closer to front sides on lower surface sides of the arm portion 103b of the side part 103 and the arm portion 104b of the side part 104, and the support pins 27d support rear end portions on the lower surface sides of the arm portion 103b of the side part 103 and the arm portion 104b of the side part 104, so that the pair of side parts 103 and 104 are supported at a predetermined height by the pair of side-part support portions 27 and 27 (see FIGS. 8 to 10).

Here, the pair of side parts 103 and 104 is supported at a predetermined height such that a lower surface 103c of the outer wall portion 103a of the side part 103 contacts with an upper surface 101c of the base portion 101a of the base part 101, and a lower surface 104c of the outer wall portion 104a of the side part 104 contacts with an upper surface 102c of the base portion 102a of the base part 102.

An adhesive is applied between the lower surface 103c of the outer wall portion 103a of the side part 103 and the upper surface 101c of the base portion 101a of the base part 101, and this portion forms the bonded portion A (see FIG. 4). Further, an adhesive is applied between the lower surface 104c of the outer wall portion 104a of the side part 104 and the upper surface 102c of the base portion 102a of the base part 102, and this portion forms the bonded portion B (see FIG. 4).

In a state where the pair of side parts 103 and 104 is supported by the pair of side-part support portions 27 and 27, tips of the arm portions 103b and 104b of the side parts 103 and 104 in the extending direction are disposed on front outer sides of the base portions 101a and 102a of the base parts 101 and 102 (see FIG. 3).

Furthermore, the rear-part support portions 29 and 29 each having a substantially rectangular parallelepiped shape are provided in a protruding condition from an upper surface of a vehicle rear end portion of the base 21 and slightly inward of both sides in the width direction. Rear end surfaces of both side portions of the rear part 105 in the width direction are supported by these rear-part support portions 29 and 29 (see FIGS. 7 to 10).

In a state where the rear part 105 is supported by the rear-part support portions 29 and 29, as illustrated in FIGS. 3 and 4, a lower surface 105a of one side portion of the rear part 105 in the width direction contacts with upper surfaces 101d of both side walls of the extending portion 101b of the base part 101, and the lower surface 105a of the other side portion of the rear part 105 in the width direction contacts with upper surfaces 102d of both side walls of the extending portion 102b of the base part 102. Further, front end surfaces 105b and 105b on both sides of the rear part 105 in the width direction contact with rear end surfaces 103d and 104d of the outer wall portions 103a and 104a of the pair of side parts 103 and 104, respectively (see FIG. 4).

An adhesive is applied between the lower surface 105a of one side portion of the rear part 105 in the width direction and the upper surfaces 101d of both side walls of the extending portion 101b of the base part 101, and these portions form the bonded portions C and D (see FIG. 3). In addition, an adhesive is applied between the lower surface 105a of the other side portion of the rear part 105 in the width direction and the upper surfaces 102d of both side walls of the extending portion 102b of the base part 102, and these portions form the bonded portions E and F (see FIG. 3).

The upper part 106 is supported above the pair of side parts 103 and 104 and the rear part 105 supported by the side-part support portions 27 and 27 and the rear-part support portion 29.

Specifically, as illustrated in FIG. 4, both side portions of the front tongue piece 106a of the upper part 106 in the width direction contact with the rear end side upper surfaces 103e and 104e of the outer wall portions 103a and 104a of the pair of side parts 103 and 104, respectively, and an entire area of the rear tongue piece 106b of the upper part 106 contacts with a front upper surface 105c of the rear part 105, so that the upper part 106 is supported (see FIG. 3).

An adhesive is applied between both side portions of the front tongue piece 106a of the upper part 106 in the width direction and the rear end side upper surfaces 103e and 104e of the outer wall portions 103a and 104a of the pair of side pans 103 and 104, and these portions form the bonded portions G and H (see FIG. 3). An adhesive is applied between the entire area of the rear tongue piece 106b of the upper part 106 and the front upper surface 105c of the rear part 105, and this portion forms the bonded portion I (see FIG. 3).

As illustrated in FIG. 6, the side-part support portions 27 have pressing portions 31 that press the pair of side parts 103 and 104 supported by the side-part support portions 27 from outside toward inside in the vehicle width direction.

The pressing portions 31 according to this embodiment are disposed on a side lower than the pair of support pins 27c and 27d of the side-part support portions 27 (lower end side in the Z direction in FIG. 6) and include dampers 31a, rollers 31b attached to tips of shaft portions of the dampers 31a, and coil springs 31c that are interposed on outer peripheries of the shaft portions of the dampers 31a and bias the rollers 31b. Similarly to the support pins 27c and 27d, the pressing portions 31 are installed orthogonal to the side walls 27b of the side-part support portions 27, the dampers 31a that press the rollers 31b are disposed on outer surface sides of the side-part support portions 27, and the rollers 31b and the coil springs 31c are disposed on inner surface sides of the side-part support portions 27.

A structure of each pressing portion 31 will be described in detail with reference to an enlarged view of a portion K in FIG. 6. A damper mounting hole 27e is formed in each of the side-part support portions 27. The damper 31a is inserted into the damper mounting hole 27e and attached to the damper mounting hole 27e via a pair of nuts 31d and 31d disposed outside and inside the damper mounting hole 27e. A piston 31e is slidably disposed in the damper 31a, and an internal space of the damper 31a is sealed by the piston 31e. Air having a predetermined pressure is sealed in the internal space, and the piston 31e is pressed by the air. Further, a shaft portion 31f is extended from the piston 31e, and a roller bearing 31g having a substantially U-shaped frame shape is fixed to a tip of the shaft portion 31f. The roller 31b is rotatably supported by the roller bearing 31g. Therefore, the roller 31b is pressed via the piston 31e pressed by the air having a predetermined pressure, the shaft portion 31f, and the roller bearing 31g. The coil spring 31c is interposed between the roller bearing 31g and the nut 31d disposed inside the side-part support portions 27. The coil spring 31c biases the roller 31b via the roller bearing 31g, and a pressing force acting on the roller 31b is reinforced.

The roller 31b is pressed by the damper 31a and biased by the coil spring 31c, so that the roller 31b presses the side parts 103 and 104 each from outside toward inside of a vehicle. As a result, falling of the side parts 103 and 104 is suppressed and the side parts 103 and 104 are maintained in predetermined postures. The damper 31a suppresses vibration of the coil spring 31c.

The pressing portion is not only limited to the configuration as described above, may be pressed by, for example, a member made of a rubber material, or may be pressed via a frame to be installed in a shape identical to the side parts, and is not particularly limited.

The base-part support portions 25 and 25 support the extending portions 101b and 102b of the base parts 101 and 102, and with upper surfaces thereof, both sides of the rear part 105 in the width direction contact to be supported via the bonded portions C, D, E, and F. At this time, since the rear part 105 may fall or be displaced, not only a self-weight of the rear part 105 but also a shearing force acts on the bonded portions C to F. The base-part support portions 25 and 25 serve as receiving members for receiving such a shearing force.

Further, the base-part support portions 23 and 23 support the base portions 101a and 102a of the base parts 101 and 102, and the base parts 101 and 102 are supported by the base-part support portions 25 and 25 so as to be raised from the upper surface of the base 21 by a predetermined height. Therefore, if the base-part support portions 23 and 23 do not exist, the base parts 101 and 102 will fall toward the vehicle front side. In this case, a shearing force acts on the bonded portions A and B between the outer wall portions 103a and 104a of the side parts 103 and 104 and the base portions 101a and 102a of the base parts 101 and 102. The base-part support portions 23 and 23 serve as receiving members for receiving such a shearing force.

Further, the side-part support portions 27 and 27 support the arm portions 103b and 104b of the side parts 103 and 104, these arm portions 103b and 104b are disposed above the outer wall portions 103a and 104a, and a center of gravity of the side-part support portions 27 each is located above. Therefore, the side parts 103 and 104 may fall down toward inside or outside in the vehicle width direction. Also in this case, a shearing force acts on the bonded portions A and B between the outer wall portions 103a and 104a of the side parts 103 and 104 and the base portions 101a and 102a of the base parts 101 and 102. The side-part support portions 27 serve as receiving members for receiving such a shearing force.

The rear-part support portions 29 support both sides of the rear part 105 in the width direction, but the rear part 105 may fall or be displaced. In this case, a shearing force acts on the bonded portions C, D, E, and F between both sides of the rear part 105 in the width direction and the extending portions 101b and 102b of the base parts 101 and 102. The rear-part support portions 29 serve as receiving members for receiving such a shearing force.

Only a self-weight of the upper part 106 acts on the bonded portions G and H between the front tongue piece 106a of the upper part 106 and the outer wall portions 103a and 104a of the side parts 103 and 104, and on the bonded portion I between the rear tongue piece 106b of the upper part 106 and the rear part 105, and no shearing force acts thereon. Therefore, receiving members for receiving a shearing force, such as the support portions 23, 25, 27, and 29, are not provided.

The temporary assembly jig can be appropriately changed according to shapes and number of parts to be temporarily assembled and is not limited to the above aspect. In addition, positions of the bonded portions and the number of the bonded portions in each part can be appropriately changed according to the shapes and the number of parts to be temporarily assembled and are not limited to the above aspect.

The assembly component 120 is also temporarily assembled by a temporary assembly device as described above via an uncured adhesive, and the state is maintained. The temporary assembly jig in this case has a structure corresponding to shapes of a rear side frame, a plurality of cross members, and the like constituting the assembly component 120.

In this embodiment, the conveyance means 40 that conveys the temporary assembly jig 20 is a belt conveyor. However, this conveyance means may be, for example, a roller conveyor, a self-propelled means provided in a temporary assembly jig itself, or the like and may be any means as long as a temporary assembly jig can be conveyed. As illustrated in FIG. 2, the temporary assembly jig 20 is conveyed, by the conveyance means 40, to a position in front of a temporary fixing device 50 to be described later.

Further, as illustrated in FIG. 2, in this embodiment, an adhesive application device 33 that applies the adhesive to a predetermined area of each part of the assembly component and a temporary assembly transfer device 35 that transfers each part to a predetermined position of the temporary assembly jig 20 are provided.

In this embodiment, the adhesive application device 33 is a known dispenser robot capable of supplying a predetermined amount of adhesive to a predetermined position. Furthermore, the temporary assembly transfer device 35 according to this embodiment is a known articulated robot that performs a predetermined operation by an actuator or the like, and an adsorption pad 35a is provided at a tip thereof. Note that the adhesive application device and the temporary assembly transfer device may be those other than the above aspects and are not particularly limited.

Then, an adhesive is applied to the bonded portions A, B, C, D, E, F, G, H, and I of the parts 101, 102, 103, 104, 105, and 106 by the adhesive application device 33. Next, the pails 101 to 105 are sequentially adsorbed by the adsorption pad 35a of the temporary assembly transfer device 35, mounted at predetermined positions of the temporary assembly jig 20, and supported by the support portions 23, 25, 27, and 29, and then the upper part 106 is mounted and supported on the parts 103 to 105. As a result, the parts 101 to 106 are bonded to one another via the adhesive applied to the bonded portions A to I, whereby the assembly component 100 is temporarily assembled, and the state is maintained. In this state, the pair of side parts 103 and 104 is pressed from outside toward inside in the vehicle width direction by the pressing portions 31 provided in the side-part support portions 27.

On a downstream side of the conveyance apparatus 10, a vehicle body assembly device for assembling a vehicle body formed by a plurality of components including one or more parts is installed. In other words, as illustrated in FIG. 2, on the downstream side of the conveyance apparatus 10, a temporary fixing device 50 and a welding device 60 are installed. The temporary fixing device 50 temporarily fixes the assembly component 100 to the component 110 including one part or another assembly component 120 so as to have a completed shape of a vehicle body. The welding device 60 welds bonded portions between a plurality of parts of the assembly component 100 and welds a joint portion between the assembly component 100 and the component 110 and a joint portion between the component 110 and another assembly component 120.

The temporary fixing device 50 temporarily fixes the assembly component 100 to another component 110 including one part and another assembly component 120 so as to have the completed shape of the vehicle body.

As illustrated in FIG. 2, the temporary fixing device 50 according to this embodiment includes a mounting portion 51 on which the components 100, and 110, and 120 are mounted, a plurality of lower jigs 52, 53, and 54 that support the components 100, 110, and 120 at predetermined positions, a temporary fixing transfer device 55 that transfers the components 100, 110, and 120 to the predetermined positions of the mounting portion 51, and a plurality of upper jigs 56, 57, and 58 that are disposed corresponding to the lower jigs 52, 53, and 54, correct positions of the parts of the assembly components 100 and 120, correct contact positions among the components 100, 110, and 120, or the like when sandwiching the components 100, 110, and 120.

Similarly to the temporary assembly transfer device 35, the temporary fixing transfer device 55 is a known articulated robot that performs a predetermined operation by an actuator or the like, and an adsorption pad 55a is provided at a tip thereof.

The lower jig 52 supports the assembly component 100, and the upper jig 56 is disposed above the lower jig 52 in correspondence with the lower jig 52. The lower jig 53 supports the component 110, and the upper jig 57 is disposed above the lower jig 53 in correspondence with the lower jig 53. The lower jig 54 supports the assembly component 120, and the upper jig 58 is disposed above the lower jig 54 in correspondence with the lower jig 54. Further, each of the upper jigs 56, 57, and 58 can perform a predetermined operation (mainly lifting and lowering operation) by an actuator (not illustrated) or the like and can approach and separate from the corresponding lower jigs 52, 53, and 54 so as to be at a predetermined fixed position. In addition, on the lower jigs 52, 53, and 54, pins (not illustrated) are respectively provided in a protruding condition, and these pins are inserted into insertion holes formed in predetermined parts of the respective components. Further, in the upper jigs 56, 57, and 58, fitting holes (not illustrated) into which the pins of the corresponding lower jigs 52, 53, and 54 are fitted are formed, respectively.

Then, after the lower jig 52 supports the assembly component 100 in a state where the pin of the lower jig 52 is inserted into the insertion hole of a predetermined part of the assembly component 100, the upper jig 56 moves close to the lower jig 52, the pin is fitted into the fitting hole, and the position of the assembly component 100 is corrected when the assembly component 100 is sandwiched between both of the jigs 52 and 56 such that the upper jig 56 is at a fixed position.

In addition, after the upper jig 57 supports the component 110 in a state where the pin of the lower jig 53 is inserted into the insertion hole of a predetermined part of the component 110, the upper jig 57 moves close to the lower jig 53, the pin is fitted into the fitting hole, and the position of the component 110 is corrected when the component 110 is sandwiched between both of the jigs 53 and 57 such that the upper jig 57 is at a fixed position.

Furthermore, after the upper jig 58 supports the assembly component 120 in a state where the pin of the lower jig 54 is inserted into the insertion hole of a predetermined part of the assembly component 120, the upper jig 58 moves close to the lower jig 54, the pin is fitted into the fitting hole, and the position of the assembly component 120 is corrected when the assembly component 120 is sandwiched between both of the jigs 54 and 58 such that the upper jig 58 is at a fixed position.

As described above, in this embodiment, the positions of the parts are corrected by the pins of the lower jigs, the fitting holes of the upper jigs, the insertion holes of the parts, and the like, but position correction structures of the parts are merely examples and are not limited to the above aspect.

In addition, the upper jigs 56 and 58 are respectively provided with clampers 56a and 58a that grip unstable portions of predetermined parts in order to suppress inclination, falling, and the like of the predetermined parts constituting the assembly components 100 and 120. Note that the clamper 56a of the upper jig 56 grips unstable portions of parts other than the pair of base parts 101 and 102, that is, the pair of side parts 103 and 104, the rear part 105, and the upper part 106.

Then, the assembly component 100 conveyed by the conveyance means 40 is adsorbed, while the temporarily assembled state is maintained, by the adsorption pad 55a, transferred toward the mounting portion 51 of the temporary fixing device 50, and supported by the predetermined lower jig 52. Similarly, the assembly component 120 is transferred toward the mounting portion 51 of the temporary fixing device 50 by the temporary fixing transfer device 55 and supported by the predetermined lower jig 53 on a side behind the assembly component 100. Further, the component 110 including one part is transferred toward the mounting portion 51 of the temporary fixing device 50 by the temporary fixing transfer device 55, disposed between both the assembly components 100 and 120, and supported by the predetermined lower jig 54 in a state of being joined to predetermined areas of the assembly components 100 and 120. When the components 100, 110, and 120 are supported by the lower jigs 52, 53, and 54, the pins provided in the lower jigs 52, 53, and 54 are inserted into the insertion holes formed in predetermined parts of the components 100, 110, and 120. As a result, the assembly components 100 and 120 in a vehicle front-rear are joined to each other via the component 110, and a vehicle body is temporarily fixed so as to have a completed shape.

At this time, even when the parts 101, 102, 103, 104, 105, and 106 constituting the assembly component 100 are displaced from predetermined positions, a position of a predetermined part is corrected, when the predetermined part is sandwiched by both of the jigs 52 and 56, such that the upper jig 56 moves close to the lower jig 52, the pin is fitted into the fitting hole, and the upper jig 56 is placed at a fixed position. At this time, the parts 101 to 106 have the bonded portions A to I boded with an uncured adhesive, but the viscosity of the adhesive decreases to become liquid as the predetermined part is sandwiched by both of the jigs 52 and 56 and a shearing force is continuously applied, so that the position can be corrected. Further, when the component 110 is displaced, the position thereof is corrected so that the upper jig 57 is at a fixed position when the component 110 is sandwiched between the upper jig 57 and the lower jig 53, and when the assembly component 120 is displaced, the position thereof is corrected so that the upper jig 58 is at a fixed position when the assembly component 120 is sandwiched between the upper jig 58 and the lower jig 54.

The welding device 60 is configured to weld the bonded portions A, B, C, D, E, F, G, H, and I between the parts 101, 102, 103, 104, 105, and 106 of the assembly component 100 and weld the joint portion between the assembly component 100 and the component 110 and the joint portion between the component 110 and the assembly component 120. The welding device 60 according to this embodiment is a known articulated welding robot that executes spot-welding by performing a predetermined operation by an actuator or the like. The welding device may be those other than the above aspect and is not particularly limited.

The welding device 60 spot-welds predetermined welding areas on the bonded portions A to I of the assembly component 100, so that heat of the spot-welding is transmitted to an uncured adhesive. In this embodiment, as illustrated in FIG. 3, areas denoted by a reference sign “x” are areas that have been spot-welded in a state where two of a plate material constituting each part are superimposed (two-ply spot-welding). In addition, as illustrated in FIG. 3, areas denoted by a reference sign “o” are areas that have been spot-welded in a state where three of the plate material constituting each part are superimposed (three-ply spot-welding). The welding areas are not limited to the above areas and can be appropriately set according to shapes and structures of parts.

Then, an uncured adhesive is heated by spot-welding the areas denoted by reference signs “x” and “o” on the bonded portions A to I of the assembly component 100. Thereafter, by disposing the assembly component 100 in a coating drying booth (not illustrated) for a predetermined time, the adhesive is cured, and the parts 101 to 106 are firmly joined to each other. In other words, the assembly component 100 disposed in the coating drying booth (not illustrated) is held for a predetermined time in an electrodeposition baking window as illustrated in FIG. 5, whereby the adhesive is cured. The joint portions of the components 100, 110, and 120 are spot-welded by the welding device 60, so that a vehicle body temporarily fixed in a completed shape is fully fixed and integrated.

Next, an embodiment of a vehicle component conveyance method according to the present invention using the vehicle component conveyance apparatus 10 will be described.

In other words, a vehicle component conveyance method according to this embodiment (hereinafter also simply referred to as the “conveyance method”) is for conveying the assembly component 100 temporarily assembled by bonding, with an uncured adhesive, contact portions of the parts 101, 102, 103, 104, 105, and 106, wherein the pair of side parts 103 and 104 is pressed from outside toward inside in the vehicle width direction to convey the assembly component 100 while maintaining a temporarily assembled state thereof, in a state where the temporary assembly jig 20 conveyed by the conveyance means 40 supports: the pair of base parts 101 and 102; the pair of side parts 103 and 104 outside of the pair of base parts 101 and 102 and at a predetermined height; the rear part 105 behind the pair of base parts 101 and 102; and the upper part 106 above the pair of side parts 103 and 104 and the rear part 105 (the above process will be described as a “conveyance process” below).

In the present embodiment, after the assembly component 100 is conveyed by the conveyance method described above, a temporary fixing process and a welding process are included. In the temporary fixing process, the assembly component 100 is temporarily fixed to the component 110 including one part or another assembly component 120 including the parts so as to have a completed shape of a vehicle body. In the welding process, the bonded portions between the parts of the assembly component 100, the joint portion between the assembly component 100 and the assembly component 120, and joint portion between the component 110 and another assembly component 120 are welded.

(Conveyance Process)

As a premise, the temporary assembly jig 20 is disposed on an upstream side of the conveyance means 40. Then, an adhesive is applied to the bonded portions A, B, C, D, E, F, G, H, and I of the parts 101, 102, 103, 104, 105, and 106 by the adhesive application device 33. Thereafter, the parts 101 to 105 are sequentially adsorbed by the adsorption pad 35a of the temporary assembly transfer device 35 and mounted at the predetermined positions of the temporary assembly jig 20.

More specifically, the base part 101 is supported by the base-part support portions 23 and 25 provided on one side of the base 21 in the width direction, and the base part 102 is supported by the base-part support portions 23 and 25 provided on the other side of the base 21 in the width direction (see FIG. 7).

Thereafter, the side part 103 is supported at a predetermined height by one of the side-part support portions 27, pressed from outside toward inside of a vehicle by the pressing portion 31, and maintained in a predetermined posture by suppressing falling (see FIG. 8). Similarly, the side part 104 is supported at a predetermined height by the other of the side-part support portions 27, pressed from outside toward inside of a vehicle by the pressing portion 31, and maintained in a predetermined posture by suppressing falling. The base part 101 and the side part 103 are bonded at the bonded portion A, and the base part 102 and the side part 104 are bonded at the bonded portion B.

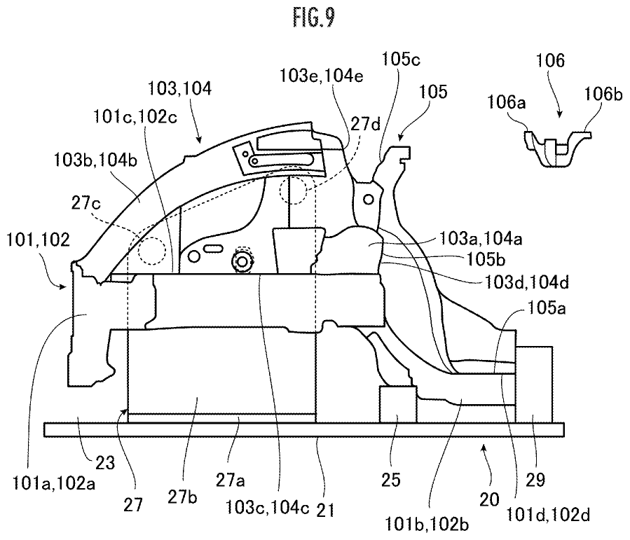

Thereafter, when both side portions of the rear part 105 in the width direction are supported by the pair of rear-part support portions 29 and 29 (see FIG. 9), one of the side portions of the rear part 105 in the width direction is bonded to the base part 101 at the bonded portions C and D, and the other of the side portions in the width direction is bonded to the base part 101 at the bonded portions E and F.

Further, when the upper part 106 is mounted and supported above the rear part 105 and the pair of side parts 103 and 104 (see FIG. 10), both sides of the front tongue piece 106a of the upper part 106 in the width direction are bonded to the pair of side parts 103 and 104 at the bonded portions G and H, and the entire area of the rear tongue piece 106b of the upper part 106 is bonded to the rear part 105 at the bonded portion I.

In this way, the parts 101 to 106 bonded to each other at the bonded portions A to I to which an uncured adhesive is applied, and the temporarily assembled state is maintained. The temporary assembly jig 20 is conveyed to a front side of the temporary fixing device 50 by the conveyance means 40 while the temporarily assembled state of the assembly component 100 is maintained.

(Temporary Fixing Process)

Then, the temporary fixing transfer device 55 of the temporary fixing device 50 transfers the assembly component 100, while maintaining the temporarily assembled state thereof, toward the mounting portion 51 of the temporary fixing device 50 to be supported by the lower jig 52. Similarly, the temporary fixing transfer device 55 transfers the assembly component 120 toward the side behind the assembly component 100 to be supported by the predetermined lower jig 54. Further, the temporary fixing transfer device 55 disposes the component 110 including one part between the assembly components 100 and 120 to be supported by the lower jig 53 in a state of being joined to predetermined areas of the components 100 and 110. Thereafter, the upper jig 56 moves close to the lower jig 52 to sandwich the assembly component 100 by both of the jigs 52 and 56, the upper jig 58 moves close to the lower jig 54 to sandwich the assembly component 120 by both of the jigs 54 and 58, and the upper jig 57 moves close to the lower jig 53 to sandwich the component 110 by both of the jigs 53 and 57. As a result, the assembly components 100 and 120 in the vehicle front-rear are joined to each other via the component 110, and a vehicle body is temporarily fixed so as to have a completed shape (see FIG. 2).

At this time, when the parts 101, 102, 103, 104, 105, and 106 of the assembly component 100 are displaced, a position of a predetermined part is, as described above, corrected, when the predetermined part is sandwiched by both of the jigs 52 and 56, such that the upper jig 56 moves close to the lower jig 52, the pin is fitted into the fitting hole, and the upper jig 56 is at a fixed position. At this time, the parts 101 to 106 have the bonded portions A to I bonded with an uncured adhesive, but by continuously applying a shearing force by the temporary fixing transfer device 55, the viscosity of the adhesive decreases to become liquid, which enables position correction. When the component 110 is displaced, the position thereof is corrected, as described above, so that the upper jig 57 is at a fixed position when sandwiching the component 110 with the lower jig 53, and when the assembly component 120 is displaced, the position thereof is corrected so that the upper jig 58 is at a fixed position when sandwiching the assembly component 120 with the lower jig 54.

(Welding Process)

And then, the welding device 60 spot-welds predetermined welding areas (areas indicated by reference signs “x” and “o” in FIG. 3) on the bonded portions A to I of the assembly component 100. Then, the heat is transferred to an uncured adhesive, and the adhesive is heated. Thereafter, by disposing the assembly component 100 in the coating drying booth (not illustrated) for a predetermined time, the adhesive is cured, and the parts 101 to 106 can be firmly joined to each other. The joint portion between the assembly component 100 and the component 110 and the joint portion between the component 110 and the assembly component 120 are spot-welded by the welding device 60. As a result, the components 100, 110, and 120 of a vehicle body temporarily fixed into a completed shape are permanently fixed to one another, and an integrated vehicle body can be assembled.

In a welding device and a welding method according to the present embodiment, as described above, a joint portion between an assembly component and another component is welded, as the joint portion between the assembly component 100 disposed at the vehicle front and the component 110 including one part disposed behind the assembly component 100, and the joint portion between the component 110 and the assembly component 120 disposed behind the component 110 are welded, respectively. However, when a vehicle body is formed by assembling only a plurality of assembly components without a component including one part, joint portions among the assembly components are welded. Further, for example, when a vehicle body is formed by a plurality of assembly components disposed continuously in the vehicle front-rear and a component including one part behind the assembly components, both of joint portions among the assembly components and a joint portion between the assembly component and another component are welded.

The vehicle component conveyance apparatus and the vehicle component conveyance method described above have the following effects.

In other words, the assembly component 100 temporarily assembled with an uncured adhesive is conveyed while pressing the pair of side parts 103 and 104 from outside toward inside in the vehicle width direction in a state where the pair of base parts 101 and 102, the pair of side parts 103 and 104, the rear part 105, and the upper part 106 are each supported.

Therefore, even if an uncured adhesive is used, it is possible to easily convey the assembly component 100 while maintaining the postures of the pair of base parts 101 and 102, the pair of side parts 103 and 104, and the rear part 105 without pressurizing between the parts by a press or the like as in Patent Literature 1. In addition, it is easy to maintain the posture of the pair of side parts 103 and 104 that are easy to fall. In brief, when a posture of each part is not maintained, it is necessary to correct the posture of each part, and workability is deteriorated, but in the present invention, workability of a welding work after conveyance, and the like can be improved.

Further, since the pressing portion 31 can have a relatively simple configuration, a large-scale device such as a pressing machine that pressurizes a joint portion of an adherend as in the invention of Patent Literature 1 described above is unnecessary, and a pressing process is also unnecessary, so that the assembly component 100 can be smoothly conveyed.

Furthermore, in the present embodiment, the pair of base parts 101 and 102 has a bilaterally symmetrical symmetry shape, and the pair of side parts 103 and 104 also has a bilaterally symmetrical symmetry shape, and thus, it is possible to convey the assembly component 100 while maintaining a bilateral shape of an entire vehicle body frame in a well-balanced manner. (* Consideration was given to the effects of the symmetry shape. They will be deleted, if unnecessary.)

Note that the present invention is not limited to the above-described embodiment, and various modifications can be made within the scope of the gist of the present invention, and such embodiments are also included in the scope of the present invention.

### REFERENCE SIGNS LIST

10 vehicle component conveyance apparatus (conveyance apparatus)
20 temporary assembly jig
21 base
23 base-part support portion
25 base-part support portion
27 side-part support portion
29 rear-part support portion
31 pressing portion
33 adhesive application device
35 temporary assembly transfer device
40 conveyance means
50 temporary fixing device
52, 53, 54 lower jig
55 temporary fixing transfer device
56, 57, 58 upper jig
60 welding device
100 assembly component
110 component
120 assembly component
101, 102 base part
103, 104 side part
105 rear part
106 upper part
A, B, C, D, E, F, G, H, I bonded portion

1. A vehicle component conveyance apparatus that conveys an assembly component temporarily assembled by bonding, with an uncured adhesive, contact portions of a pair of base parts disposed on both sides in a vehicle width direction, a pair of side parts disposed in contact with an outside of the pair of base parts, a rear part disposed in contact with a vehicle rear side of the pair of base parts, and an upper part disposed in contact with a vehicle upper side of the pair of side parts and the rear part, the vehicle component conveyance apparatus comprising a temporary assembly jig that maintains a temporary assembling state of the assembly component, and a conveyance unit that conveys the temporary assembly jig, wherein
the temporary assembly jig includes a base, a base-part support portion that supports the pair of base parts, a side-part support portion that supports the pair of side parts at a predetermined height, and a rear-part support portion that is provided on the vehicle rear side behind the base-part support portion and the side-part support portion and supports the rear part,
the upper part is supported above the pair of side parts and the rear part supported by the side-part support portion and the rear-part support portion, and
the side-part support portion includes a pressing portion that presses the pair of side parts supported by the side-part support portion from outside toward inside in the vehicle width direction.

2. A vehicle component conveyance method for conveying an assembly component temporarily assembled by bonding, with an uncured adhesive, contact portions of a pair of base parts disposed on both sides in a vehicle width direction, a pair of side parts disposed in contact with an outside of the pair of base parts, a rear part disposed in contact with a vehicle rear side of the pair of base parts, and an upper part disposed in contact with a vehicle upper side of the pair of side parts and the rear part, wherein
the pair of side parts are pressed from outside toward inside in the vehicle width direction to convey the assembly component while maintaining a temporarily assembled state of the assembly component,
in a state where a temporary assembly jig conveyed by a conveyance unit supports:
the pair of base parts;
the pair of side parts outside of the pair of base parts and at a predetermined height;
the rear part behind the pair of base parts; and
the upper part above the pair of side parts and the rear part.
